(19) United States
(12) Patent Application Publication
(10) Pub. No.: US 2015/0211415 A1
(43) Pub. Date: Jul. 30, 2015

(54) IMPROVEMENT TO A TWO-STROKE ENGINE WITH V ALV E EFFECT

(71) Applicant: Mauro Otmar KISSMANN, Distrito Arroio Bonito (BR)

(72) Inventor: Mauro Otmar KISSMANN, Distrito Arroio Bonito (BR)

(21) Appl. No.: 14/620,137

(22) Filed: Feb. 11, 2015

Related U.S. Application Data
(63) Continuation of application No. PCT/BR2013/000239, filed on Jul. 3, 2013.

(30) Foreign Application Priority Data
Aug. 24, 2012 (BR) BR1020120213320

(51) Int. Cl. F02B 75/26; F02B 33/04; F02B 75/02

(52) U.S. Cl. CPC F02B 75/265; F02B 75/02; F02B 33/04; F02B 2075/025

(57) ABSTRACT

An improvement to a two-stroke engine with valve effect wherein the cylinder (10) is shifted forward with respect to the direction of rotation of the crankshaft (60) such that, in the expansion phase, the connecting rod (50) reduces the angle of action on the crankshaft (60), minimizing friction of the piston (40) against the cylinder (10) and increasing the “useful angle of rotation of the crankshaft (60)” with respect to the same stroke of the piston (40), sealing efficiently the exhaust port (11), preventing loss of gases, improving pre-compression, and reducing a compression leak.

### CROSS-REFERENCE TO RELATED APPLICATIONS

This Application is a CONTINUATION application claiming the benefit of priority of the International Patent Application No. PCT/BR2013/000239 with an international filing date 3 Jul. 2013 that designated the United States, which claims the benefit of priority of Federal Republic of Brazil Application No. BR 10 2012 021332 0, filed 24 Aug. 2012, the entire disclosures of each (and all) of which Applications are expressly incorporated by reference in their entirety herein.

### FIELD OF THE INVENTION

This invention relates to an improvement to a two-stroke engine with valve effect. More particularly, this invention relates to a two-stroke engine in which the cylinder is shifted forward with respect to the direction of crankshaft rotation such that, in the expansion phase, the connecting rod reduces the angle of action on the crankshaft, minimizing friction of the piston against the cylinder and increasing the “useful angle of rotation of the crankshaft” with respect to the same piston stroke.

### PRIOR ART

A two-stroke engine is an internal combustion engine which completes a cycle of intake, compression, expansion, and exhaust in each revolution of the axle with the intake stroke and the compression stroke happening simultaneously.

A stroke is the movement of the piston from bottom dead center (BDC) to top dead center (TDC).

On the first stroke of the engine, called a compression stroke, supposing that said engine is already running, as the piston travels upward to top dead center (zero degree reference for the crankshaft angle), it compresses the mixture in the combustion chamber, creates a rarefaction in the crankcase, and at the same time closes off the exhaust port. As it approaches top dead center, the mixture is ignited and combusted and at the same time the gaseous mixture formed by air and fuel due to the rarefaction created during the upward movement of the piston is drawn into the crankcase.

On the second stroke of the engine, called an expansion phase, the combustion gases expand and make the piston move downward, thus compressing the mixture in the crankcase. As it approaches bottom dead center (BDC) (the crank angle is 180°), the piston opens the exhaust port, allowing the burned gases to flow out. Then, the transfer port is opened and the compressed mixture flows into the combustion chamber, forcing the burned gases to flow through the exhaust port due to the pressure difference.

Therefore, any modification to the exhaust port of the two-stroke engine affects the performance. To this end, the prior art discloses solutions to optimize power and torque and reduce the consumption such as an inclusion of valves into the exhaust port to control the gas outflow.

The output of an exhaust port is its capacity of making the highest amount of burned gasses pass through it in the shortest time possible. The height determines the time during which the port will remain open allowing the gasses to flow out. Theoretically, when the height is increased, it is possible to use a wider rev range. That is, the exhaust port is placed higher in engines with a wide rev range as in sports cars. However, this height has its limit that is why the section or format of the port also has its function. When the height of the exhaust port is changed, the engine gains in power at high rpm and loses torque at low rpm. As for the format of the port, a very wide port compromises the durability of piston rings.

Furthermore, some two-stroke engines rely on the addition of mixture intake control valves whose purpose is to increase the fresh mixture intake time and prevent its backflow into the carburetor. In other engines, a piston skirt serves the same function as said control valves.

Although the addition of valves to the exhaust port and/or at the entrance of the mixture improves power distribution, it increases the manufacturing cost of the engine, requires more frequent maintenance due to valve carbonization and, mainly, makes a two-stroke engine whose strength is simplicity more complex.

Another alternative is to tilt the cylinder forward or backward, around 15 degrees, but top dead center and bottom dead center are kept aligned and the connecting rod head is moved away from the piston line. In this arrangement, the intense friction of the piston against the cylinder is maintained, mainly in the expansion phase.

Therefore, to optimize the output of two-stroke engines without adding moving parts, which is the conventional solution of the prior art, or without tilting the cylinder, is to tilt the cylinder forward with respect to the direction of rotation of the crankshaft, with the cylinder clearance equal to, or smaller than, the radius of the crankshaft such that the connecting rod approaches the piston line in the expansion phase, reducing the angle of action on the crankshaft and friction between the piston and the cylinder, and increasing the useful angle of rotation of the crankshaft with respect to the same stroke of the piston, this technical solution being described and claimed herein.

### SUMMARY

It is an object of the present invention to provide an improvement to a two-stroke engine that betters the efficiency by using less fuel in order to achieve the same result.

It is another object of the present invention to provide an improvement to a two-stroke engine that provides less advanced ignition timing due to the fact that the speed at which the piston descends in the expansion phase is lower, which keeps combustion pressure longer.

It is another object of the present invention to provide an improvement to a two-stroke engine that improves the gas pumping capacity wherein the piston seals more efficiently the exhaust port while being forced against said port.

It is another object of the present invention to provide an improvement to a two-stroke engine that increases the full travel of the piston without increasing the crankshaft radius and the size of the crankcase, thus increasing the engine displacement.

It is another object of the present invention to provide an improvement to a two-stroke engine that provides a faster compression stroke with less time for a compression leak.

It is another object of the present invention to provide an improvement to a two-stroke engine that slows the piston down and makes the piston move less for the same angle of rotation of the crankshaft during the expansion phase and up to the uncovering of the exhaust port due to the fact that the connecting rod moves closer to the piston line.

It is another object of the present invention to provide an improvement to a two-stroke engine that ensures less friction of the piston on the expansion stroke, considering that the connecting rod is aligned or almost aligned with the piston movement line.

It is another object of the present invention to provide an improvement to a two-stroke engine that increases the pumping capacity because after the exhaust port is uncovered, the connecting rod moves away from the piston line and descends more because the parallel line of bottom dead center is further away than the parallel line of top dead center with respect to the piston line such that the descent angle of the crankshaft in the expansion phase from TDC to BDC is greater than 180° and also because the connecting rod moves away from the piston line such that said piston descends faster from the uncovering of the exhaust port to BDC, which makes pre-compression in the crankcase stronger and transfer of gases easier.

It is another object of the present invention to provide an improvement to a two-stroke engine that the uncovering of the exhaust port and transfer occur faster because the piston descends faster from the exhaust opening to bottom dead center faster due to the fact that the connecting rod moves away from the piston movement line from the beginning of the uncovering of the exhaust port to bottom dead center.

It is another object of the present invention to provide an improvement to a two-stroke engine that increases the total engine displacement because the parallel line of bottom dead center is further away than the parallel line of top dead center with respect to the piston movement line without altering the piston, cylinder, connecting rod or crankshaft clearance.

### BRIEF DESCRIPTION OF THE DRAWINGS

FIG. 1A shows schematically a two-stroke engine of the prior art, illustrating the intake of the mixture through the intake port as the piston moves upward approaching top dead center (TDC) and compressing the mixture in the cylinder, and FIG. 1B shows schematically the two-stroke engine, subject matter hereof.

FIG. 2A shows schematically a two-stroke engine of the prior art, illustrating expulsion of burned gases through the exhaust port, as the piston moves downward approaching bottom dead center (BDC), and the uncovering of the exhaust port, and FIG. 2B shows schematically the two-stroke engine, subject matter hereof.

FIG. 3A shows schematically a two-stroke engine of the prior art, illustrating the expansion phase as the piston moves downward, compressing the mixture in the crankcase, and FIG. 3B shows the two-stroke engine, subject matter hereof, demonstrating the moment the exhaust port is uncovered (UEP).

FIG. 4A shows schematically a two-stroke engine of the prior art, illustrating the compression phase as the piston moves upward, compressing the mixture in the cylinder and opening the mixture intake port as it approaches TDC, and FIG. 4B shows the two-stroke engine, subject matter hereof, demonstrating the moment the exhaust port is closed off (CEP).

FIG. 5A shows schematically a two-stroke engine of the prior art, illustrating bottom dead center (BDC), top dead center (TDC), the uncovering of the exhaust port (UEP), and the closing off of the exhaust port (CEP), and FIG. 5B showing schematically the two-stroke engine, subject matter hereof.

### DETAILED DESCRIPTION OF THE INVENTION

The improvement to a two-stroke engine, subject matter of the present invention, comprises a two-stroke engine in which the cylinder is shifted forward with respect to the direction of rotation of the crankshaft such that the connecting rod reduces the angle of action on the crankshaft in the expansion phase, minimizing friction of the piston against the cylinder and increasing the “useful angle of revolution of the crankshaft” with respect to the same piston stroke.

In this arrangement, the cylinder is shifted forward and the connecting rod approaches the piston line in the expansion phase, thus increasing the engine angle of revolution of the crankshaft with respect to the same stroke of the piston wherein the tilt angle of the connecting rod with respect to the piston stroke line has a greater value at the beginning of the piston stroke and a value practically equal to zero in the middle of the piston stroke.

This reduction in the angle of action of the connecting rod on the crankshaft precisely in the phase of the greatest combustion pressure makes the connecting rod force the piston less against the cylinder wall, thus wasting less energy by friction and reducing wear.

As the useful angle of revolution of the crankshaft with respect to the piston stroke in the expansion phase is increased by degrees, the driving force of the engine increases, providing an effect similar to the effect obtained when valves are disposed on the exhaust port.

A two-stroke engine, subject matter hereof, comprises a cylinder (10) having a gas exhaust port (11) and an air-fuel mixture intake port (12) wherein said cylinder (10) has a piston (40) that works as a slide valve.

In the cylinder (10), the upper region limited below by the piston (40) is the combustion chamber (20) and the lower region limited above by the piston (40) is the crankcase (30), which communicates with the cylinder (10) through a transfer channel (13).

As the piston (40) moves downward (compression phase), it compresses the air-fuel mixture in the combustion chamber (20) and at the same time, vacuum is generated in the crankcase (30) that draws in the air-fuel mixture through the intake port (12). In the descending phase (expansion phase), the piston (40) pressurizes the crankcase (30) so that the mixture can be transferred to the cylinder through the transfer channel (13) wherein the movement of the piston (40) uncovers and closes off the exhaust port (11) or the intake port (12), and the transference channel (13).

The piston (40) is attached below to a connecting rod (50) which is attached to floating bearings of the crank of the crankshaft (60).

The cylinder (10) is shifted forward with respect to the direction of rotation of the crankshaft (60), the cylinder clearance (10) with respect to the center of the crankshaft (60) equal to the crank radius.

As the cylinder (10) moves forward with respect to the direction of rotation of the crankshaft (60), the connecting rod (50) is tilted vertically, moving jointly the piston (40) which is forced against the wall of the front portion of the cylinder (10) in order to seal more efficiently the exhaust port (11), thus preventing loss of gasses, improving pre-compression, and reducing a compression leak.

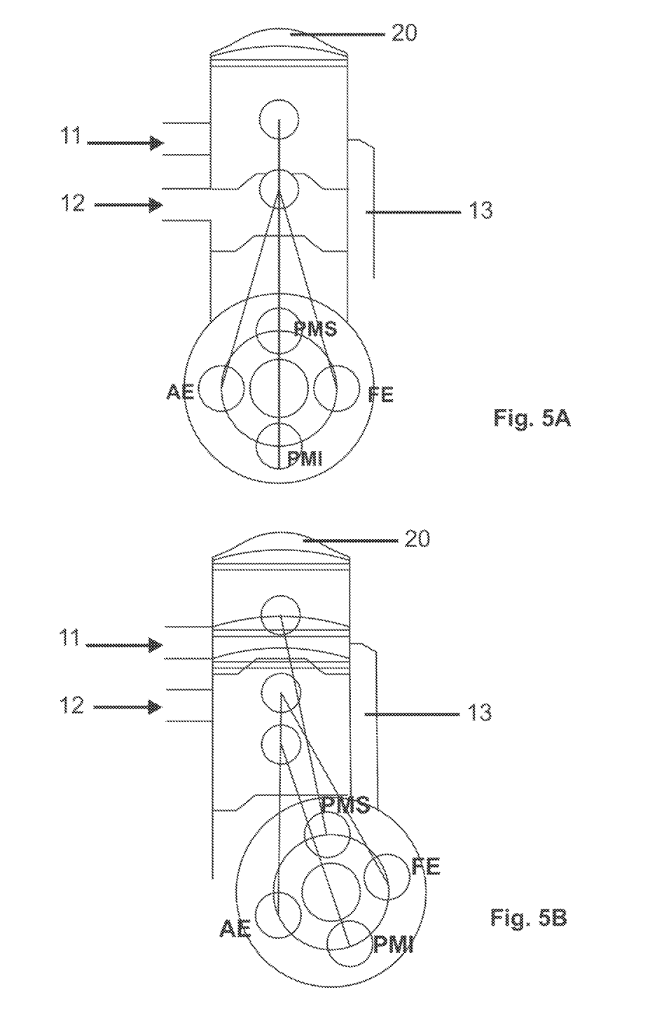

In two-stroke engines of the prior art, the bottom dead center line is parallel to the top dead center line as shown in FIG. 5A while in this invention, bottom dead center is shifted in the horizontal plane from top dead center with respect to the piston movement line as shown in FIG. 5B.

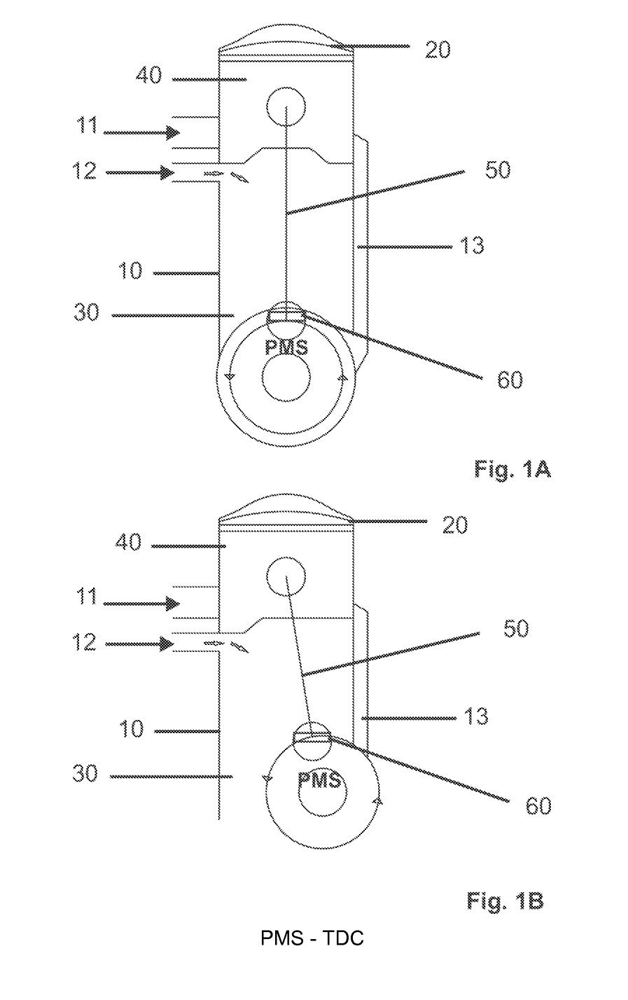

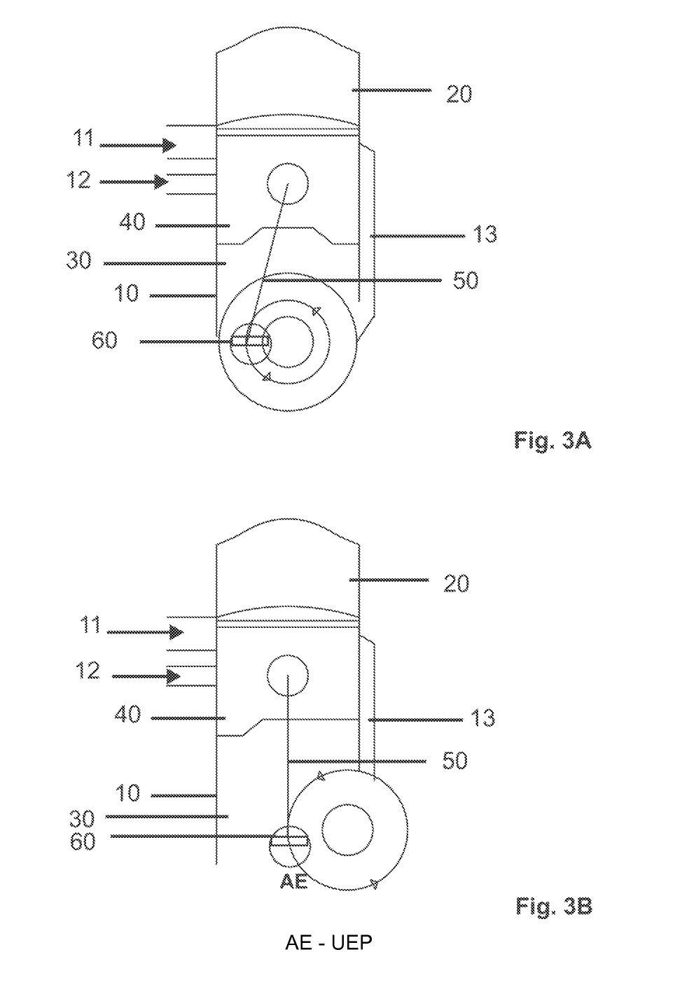

In the expansion phase as shown in FIGS. 1B and 3B, the end portion of the connecting rod (50) moves towards the piston stroke line as the piston (40) approaches the exhaust port (11). In this situation, the piston (40) descends slower with a smaller linear displacement for the same angle of rotation of the crankshaft (60), which provides a greater ignition phase without increasing the stroke of the piston (40) and, while keeping the pressure longer, the ignition timing can be less advanced.

In the expansion phase, because of the vertical movement of the connecting rod (50) with respect to the piston (40), said piston (40) starts having less friction with the wall of the cylinder (10) once the connecting rod (50) is parallel or next to the piston movement line for the major part of the stroke, closing off efficiently the exhaust port (11), thus preventing loss of pre-compression in the crankcase (30).

Comparatively, in two-stroke engines of the prior art, the end portion of the connecting rod moves away from the piston movement line as the piston approaches the exhaust port as shown in FIG. 3A, increasing the tilt angle of the connecting rod with respect to the piston movement and, therefore, increasing the pressure of the piston against the back wall of the cylinder, causing more friction, loss of energy, and sealing in an inefficient manner the exhaust port because the piston rests on the intake side. Also, the piston moves more and faster for the same useful angel of rotation of the crankshaft.

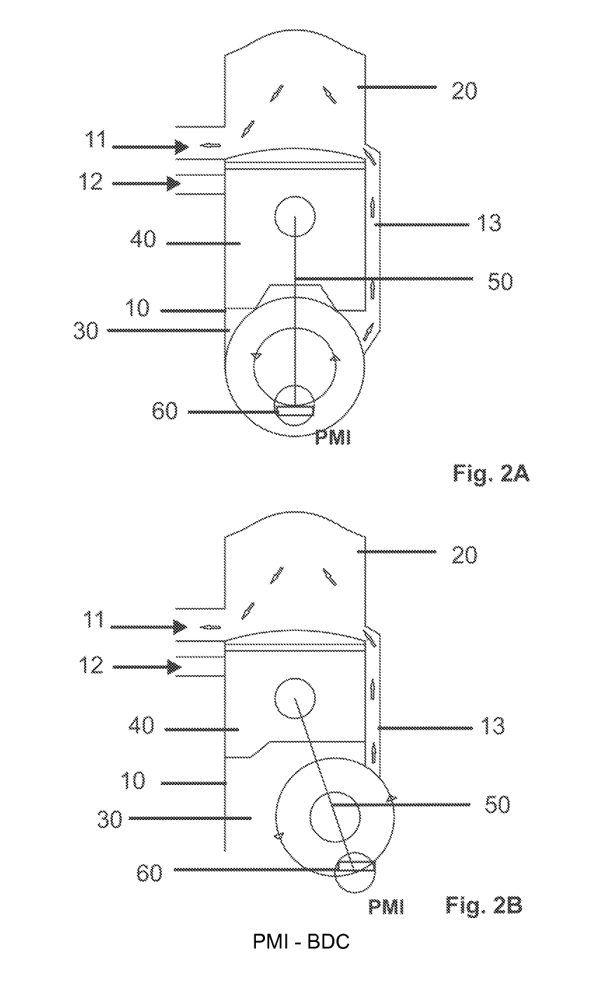

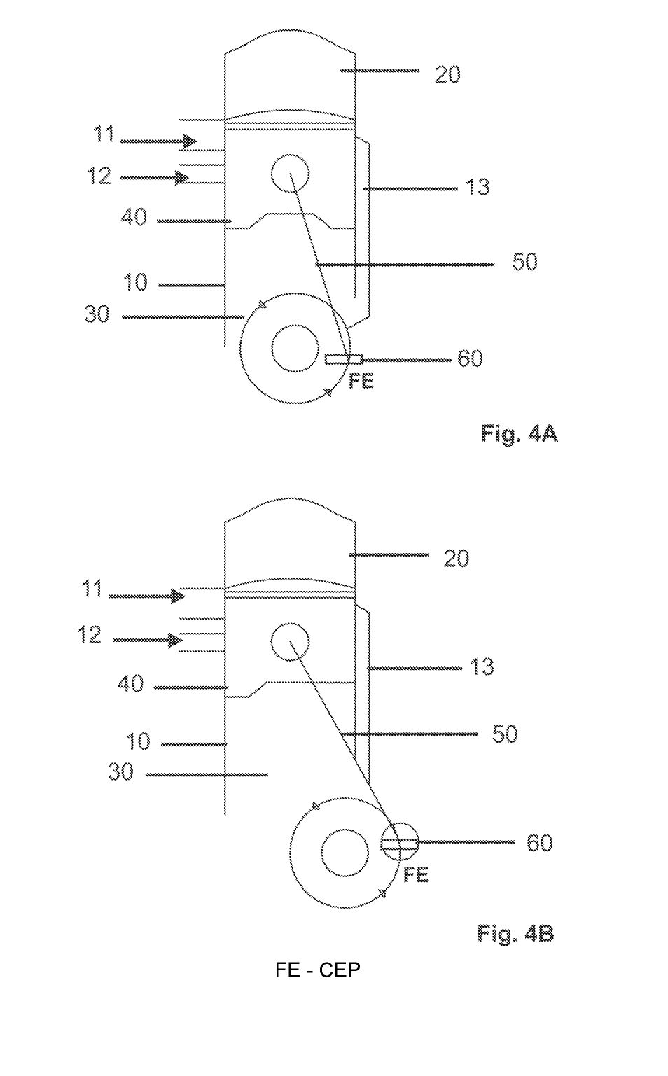

In the compression phase, as shown in FIGS. 2B and 4B, the connecting rod (50) pushes the piston (40) upward towards top dead center (TDC). Thus, the end portion of the connecting rod (50) moves upward jointly with the piston (40) and approaches concomitantly the piston movement line such that said piston (40) describes a stroke faster compared to the expansion phase because the angle of rotation of the crankshaft (60) is smaller. Therefore, the compression of gasses occurs faster than in two-stroke engines of the prior art and in less time for a compression leak or pre-ignition to happen compared to the expansion time in the engine, subject matter hereof.

As the compression time is shortened, the air-fuel mixture intake is faster.

In comparison with two-stroke engines of the prior art, as the piston (40) moves upward faster in the compression phase, a lower pressure area is created in the crankcase (30) and, after ignition, as the piston (40) is slower, it makes the low pressure area in the crankcase (30) remain longer, thus allowing more efficient intake. While in two-stroke engines of the prior art, the piston moves upward slower and downward faster, thus reducing the intake time because the piston descends faster after top dead center impairing the “breathing” of the engine.

As shown in FIG. 5B, the stroke of the piston (40) in the descending phase (expansion stroke) is equal to the ascending stroke (compression stroke), but the angle of rotation of the crankshaft (60) is greater in the descending phase. This happens because the BDC parallel line is further away from the TDC parallel line with respect to the line of the piston (40), thus creating the angle of rotation of the crankshaft (60) in the descending phase greater than 180°, and the angle of rotation of the crankshaft (60) in the ascending phase smaller than 180°, the same stroke of the piston being maintained (40).

The improvement to two-stroke engines, subject matter hereof, can be applied to inverted cylinders, that is, those that have an intake port in front of the exhaust port in the back portion of the cylinder, maintaining the valve effect although some advantages of this arrangement are lost.

Equally, in two-stroke engines where intake is controlled by the piston skirt, the arrangement proposed herein can be applied by making adjustments between the piston skirt and the intake port.

The improvement to two-stroke engines can be used in conjunction with traditional exhaust valves.

What is claimed is:

1. Improvement to a two-stroke engine with valve effect comprising a cylinder (10) having an exhaust port (11) and an air-fuel mixture intake port (12) wherein said cylinder (10) having a piston (40) works as a slide valve, wherein the upper region of the cylinder (10) limited below by the piston (40) is a combustion chamber (20) and the lower region limited above by the piston (40) is a crankcase (30), which communicates with the cylinder (10) through a transfer channel (13), wherein said piston (40) is attached below to a connecting rod (50) which is attached to floating bearings of the crank of the crankshaft (60), wherein said cylinder (10) is shifted forward with respect to the direction of rotation of the crankshaft (60) with cylinder clearance with respect to the center of the crankshaft (60) equal to the radius of the crankshaft, the connecting rod (50) being disposed vertically tilted, moving jointly with the piston (40) which is forced against the wall of the front portion of the cylinder (10) with bottom dead center shifted in the horizontal plane from top dead center with respect to the piston movement line.

2. Improvement to a two-stroke engine with valve effect as claimed in claim 01 wherein, in the expansion phase, the end portion of the connecting rod (50) moves towards the piston movement line as the piston (40) approaches the exhaust port (11) wherein the linear movement of said piston (40) is smaller for the same angle of rotation of the crankshaft (60) wherein BDC parallel line is further away from the TDC parallel line with respect to the piston line, the angle of rotation of the crankshaft (60) being greater than 180°.

3. Improvement to a two-stroke engine with valve effect as claimed in claim 01 wherein, in the compression phase, the connecting rod (50) moves upward jointly with the piston (40) and approaches concomitantly the piston movement line, the angle of rotation of the crankshaft (60) being smaller than 180°.
